(19) United States
(12) Patent Application Publication
(10) Pub. No.: US 2023/0331353 A1
(43) Pub. Date: Oct. 19, 2023

(54) Non-metal mesh chair for marine use

(71) Applicant: Quality Mark, Inc., Shafer, MN (US)

(72) Inventor: Mark Ebbenga, Shafer, MN (US)

(21) Appl. No.: 18/133,744

(22) Filed: Apr. 12, 2023

Related U.S. Application Data
(60) Provisional application No. 63/330,588, filed on Apr. 13, 2022.

(51) Int. Cl. B63B 29/04; B60N 2/30; A47C 5/12; A47C 7/02

(52) U.S. Cl. CPC B63B 29/04; B60N 2/3009; A47C 5/12; A47C 7/0213; B63B 2029/043

(57) ABSTRACT

A non-metal seat comprising a non-metal frame work and a non-metal open mesh seating surface stretched across an opening in a base portion of the non-metal framework and a non-metal open mesh back rest surface stretched across an opening in a back support portion of the non-metal framework. The non-metal frame is constructed from plastic and the non-metal open mesh comprises a woven or knit open mesh panel comprising nylon, vinyl, or a combination thereof. The seat has a pivoting mechanism coupling the base portion to the back support portion such that the non-metal seat is a foldable seat.

### CROSS-REFERENCE TO RELATED APPLICATION

The present application claims priority to and the benefit of U.S. provisional patent application Ser. No. 63/330,588 filed on Apr. 13, 2022, the contents of which are incorporated herein in their entirety.

### BACKGROUND

The present invention relates to a non-metal, foldable, marine seat. More specifically, the present invention relates to a non-metal, mesh foldable seat for installation in watercraft.

Watercraft seating, specifically seats for boats, need to be durable and easily cleanable. Most watercraft seats are constructed with a metal frame supporting foam padding and a durable, heavy duty, thick, fabric such as vinyl fabrics which fully cover the foam padding of the seat. The material may be easy to wipe clean and is water proof given the environment of use, but such watercraft seats are prone to wear, fading and cracking. Further, sitting on these seats in the heat and sun can become uncomfortable as a user sweats. The seats are not breathable.

Watercraft seating of the prior art that does incorporate a breathable fabric includes metal frames and strap assemblies, where the fabric layer is more akin to a non-resilient cloth material, providing little to no support or durability and requiring replacement of the fabric layer after a season of use.

Watercraft seats comprise aluminum frames and heavy foam padding for comfort. These materials can be expensive as supply chain issues have increased these prices as the materials can be subject to shortages making the materials difficult to source for manufacturers, thus driving up the costs of the seats.

### SUMMARY

An aspect of the present disclosure relates to a seat for a watercraft. The seat for a watercraft has a non-metal seat frame with a first frame and a second frame, and a non-metal open mesh fabric provided on the first frame, provided on the second frame or a combination thereof.

The first frame has a perimeter frame with an opening therein and one or more cross members are provided below the opening and extending across the opening.

The opening supports a seating surface thereacross and wherein the seating surface is supported by the perimeter and wherein the one or more cross members are spaced below the seating surface and thus not in direct contact with the seating surface.

The second frame comprises a perimeter frame with an opening therein and one or more cross members are provided behind the opening and extending across the opening.

The opening supports a backrest thereacross and wherein the backrest is supported by the perimeter frame and wherein the one or more cross members are spaced behind the backrest and thus not in direct contact with the backrest surface.

One or more air flow paths are provided below or behind the non-metal open mesh fabric provided on the first frame and/or the second frame.

The first frame is provided with the non-metal open mesh fabric such that the first frame provides a seating surface configured to withstand a user seated thereon and wherein the second frame is provided with non-metal open mesh fabric such that the second frame provides a backrest surface to the seat.

The first frame and second frame are pivotally coupled together by a pivotal connection mechanism such that the seat is a selectively collapsible seat for storage and transport.

The pivotal connection mechanism is positioned at a location above a seating surface of the first frame.

The second frame is provided with a support member spaced apart from the non-metal open mesh fabric on the second frame and has an outer surface curvature.

The seat is collapsible such that the second frame is pivotal about the pivotal connection mechanism to contact the first frame and wherein the seat can double as a bump seat.

In one more embodiment, the seating surface and/or the backrest surface are each provided on a removable panel wherein the panel is removably coupled to the perimeter base frame and/or perimeter back frame.

The non-metal open mesh fabric is comprised of a knit or woven plastic, polymer, or combination thereof and wherein the fabric is stretched across one or both of the first frame and the second frame.

A first non-metal open mesh fabric panel is clamped to and stretched across the first frame, and a second non-metal open mesh fabric panel is clamped to and stretched across the second frame.

The seat comprises an attachment mechanism for installing the seat on a pre-existing seat support of the watercraft.

Another aspect of the present disclosure relates to a non-metal seat with a non-metal frame work and a non-metal open mesh seating surface stretched across an opening in a base portion of the non-metal framework and wherein the non-metal frame is constructed from plastic and the non-metal open mesh comprises a woven or knit open mesh panel comprising nylon, vinyl, or a combination thereof.

A non-metal open mesh backrest surface is stretched across an opening in a back support portion of the non-metal framework.

A pivoting mechanism couples the base portion to the backrest support portion such that the non-metal seat is a foldable seat.

The non-metal open mesh seating surface is stretched across the opening in the base portion of the non-metal framework and spaced apart from one or more frame support members extending across and below the non-metal framework such that the open mesh is not in contact with the one or more frame support members.

The non-metal open mesh backrest surface is stretched across the opening in the backrest support portion of the non-metal framework and spaced apart from a support member extending across and behind the non-metal framework such that the open mesh is not in contact with the support member.

### BRIEF DESCRIPTION OF THE DRAWINGS

FIG. 1 is a front perspective view of a non-metal seat according to one or more embodiments described herein.

FIG. 2 is a rear perspective view of the seat.

FIG. 3 is a side view of the seat.

FIG. 4 is a front view of the seat.

FIG. 5 is a rear perspective view of the seat.

FIG. 6 is a side perspective view of the seat in a folded configuration.

FIG. 7A is a top front view of a removable seat panel for insertion into the seat frame.

FIG. 7B is a side view of the removeable seat panel.

### DETAILED DESCRIPTION

A non-metal seat for marine use is described herein. The seat is comprised substantially entirely of non-metal components. That is, the seating surface and back rest surface, as well as the frame of the seat is entirely non-metal in at least one embodiment. For example, the seat is comprised of a plastic material and comprises one or more non-metal mesh surface areas for bearing a user's weight. The mesh is an open mesh, which allows for air flow through the surface area, but provides sufficient support to a user seated thereupon. The seat can be installed in various mobile environments, for example, on various watercraft, including as a replacement seat for pre-existing watercrafts.

The seat provides a breathable, easily cleanable, and comfortable seating option for marine use. The seat construction further eliminates the need for aluminum and foam components common in traditional marine seating. It is also contemplated that the plastic material used in construction of the seat may be a recycled material.

The seat comprises a frame and one or more surface areas on the frame for supporting a user. The one or more surface areas are comprised of a deformable, high strength plastic material in an open mesh construction. The open mesh construction may be provided as a woven surface area or a net-like surface area installed on the frame with sufficient tension across a width and depth of the seat, as well as across a back rest height of the seat, such that the surface areas support the user's weight thereon.

The seat also allows a user to recline or otherwise utilize the back rest portion of the seat. The material is deformable and high strength such that the tension provided when the open mesh construction is installed on the frame retains the surface area(s) in place on the frame and supports a user sitting, resting or otherwise thereon.

The seat comprises two frame sections that may be pivotally connected such that the seat is foldable. Alternatively, the non-metal seat with no-metal open mesh seating and back rest surface may be provided with a static or fixed connection between the two frame sections. It is also contemplated that the non-metal seat may be provided as a “stool” with the non-metal open mesh seating surface and without a backrest.

In one or more embodiments, the frame sections comprise a base frame section and back frame section, where for example when in an expanded or open configuration, the base frame section provides a seat section, and the back frame section is a back rest. The frame sections may comprise a perimeter framework and support or structural framework with an open space within each frame where the open mesh material is stretched thereacross. Thus, the frame supports the open mesh material in a manner where the open mesh floats over the surface areas of the seat and is only substantially supported by the frame and the perimeter edges of the seat and back rest. As noted above, these sections are pivotally coupled to one another, providing an adjustable and/or selectively configurational seat. The pivotal connection allows for the back frame section to be folded down from a substantially vertical position to a substantially horizontal position substantially parallel with the base section.

The pivotal connection point between the base frame section and back frame section may be provided at a location approximately aligned with a lower portion of the back frame section. For example, the pivot point may be provided above a surface area of the seat portion of the base frame section. An elbow may be provided to connect the base section to the back frame section and the pivotal connection point may be provided along a length of this elbow.

In one or more embodiments, the back frame section folds down to a nested position within the base frame section. As the pivotal connection is elevated, the pivotal connection along with the frame construction allows the back frame section to fold down substantially completely or otherwise at least about a full 90 degrees, to nest the back and base sections together. The back frame section may have a perimeter dimension and shape that allows the back frame section to fold down and nest directly on top of the base frame and/or within the base frame perimeter to form a compact and nested seat in a stowage and transport position. Further, as the seat does not use a foam cushion or other raised cushion material for the base and back of the seat, but instead uses a non-metal open mesh fabric or panel, the seat can more compactly fold together. The foam cushion generally adds significant height to a seat base and back making compact folding impossible.

In one or more embodiments the seat is a two-in-one seat wherein in a folded and/or nested position the seat can function as a bump seat. A user may lean against the seat in this configuration as a rear surface of the seat provides back rest option for use. A folded seat can be rested upon or leaned against and used as marine bump seat. The seat is thus a multi-use device in one or more embodiments.

The base section is comprised of a frame that may have one or more contoured areas for user comfort, such as contoured front portions for a user's legs. This may comprise a contoured area near a front edge of the frame where, for example, a user's knees would rest and a second contoured area along a depth of the frame where a user's thighs would rest. Similarly, the back frame section may comprise a shape for ergonomics and comfort.

A non-metal mesh material, referred to herein as a fabric, is stretched across the base frame section to provide the user seating surface area. The non-metal mesh fabric is also stretched across the back frame section to provide the back rest surface area to the seat. Thus, the seat provides surface areas for bearing user weight that conform to the shape of the user sat thereupon as the mesh durable, breathable, flexible and resilient. The non-metal mesh fabric may be an open mesh vinyl or nylon fabric formed by knitting or weaving, for example. The non-metal mesh fabric may be a polymer or plastic based open mesh fabric such as constructed from polyethylene, polyester, polytetrafluorethylene or combinations thereof.

The frame of the seat may also be a non-metal frame constructed from plastic such as polyamide (nylon), polypropylene or combinations thereof. For example, the frame may be constructed from modified nylon PA6/PA66 which is weather and corrosion resistant and provides stiffness to the frame. Polypropylene may be used for the frame as this provides high impact strength, stiffness and scratch resistance. The example materials for the open mesh fabric and the frame are non-limiting examples as functionally similar materials may be used to construct the open mesh marine seat. In one or more embodiments, the seat described herein eliminates the use of metals, such as aluminum, and foams, which are typically used in marine seating. For example, aluminum and foam material shortages and expense resulting therefrom can be avoided altogether by the use of a plastic, mesh, marine seat as described herein.

The seating surface area of the seat described herein comprises the non-metal mesh fabric stretched thereacross. The mesh fabric is securely held in place on the base fame and stretched thereacross with sufficient tension to support a user's weight thereon while conforming slightly to a user's body but otherwise retaining its shape across the surface area. In one or more embodiments, ends of the mesh fabric are secured to the frame perimeter via a clamping mechanism. The frame may comprise one or more clamps for holding the ends of the fabric to the frame. The frame may comprise two sections that couple together wherein the ends of the mesh fabric are secured between the two sections and are frictionally held in place. The back rest surface area may be constructed in substantially the same manner, with the mesh fabric is stretched across the back rest frame section and ends of the mesh fabric secured to the frame. Thus, the frame supports the mesh fabric stretched thereacross and maintains the tension of the mesh fabric sufficiently to support a user on the mesh-fabric.

What is meant by non-metal seat as referred to throughout this disclosure is that the frame and contact surface areas of the seat are constructed of non-metal components. The frame may be injection molded, eliminating the need for metal fasteners or other metal hardware. Plastic components may be provided for the pivotal connection, but it is also contemplated that metal pivot rods or metal hardware may be provided only at the point of pivotal connection of the frame sections.

The seat according to one or more embodiments is configured for increased air flow and to provide a cooling aspect to a user. The frame is configured with one or more open areas such that the frame provides structural support for the seating surface while maintaining one or more air flow paths between the seating surface and the base frame and/or one or more air flow paths between the back rest frame section and the back rest surface. For example, the contact surfaces may only contact the frame at perimeter connection points and as such the surface area across the contact surfaces is free-standing as the contact surfaces extend across the frame.

Additional elements may be integrally provided so as to maintain and/or increase air flow through and around the seat. For example, a handle portion for allowing the seat to be portable and used as a seat as well as a bump seat is integrally formed in a portion of the frame. The handle may be molded into the frame and the seat frame itself formed by molding such as through injection molding processes.

The base of the frame is provided with one or more open areas to provide air flow below the seating contact surface and in combination with the open mesh contact surface which has increased air flow for cooling. This increases comfort when the seat is used when boating in open water, for example, on hot days or days with full sun. This also increases comfort and reduces wear and tear on the seat when a boater is wet and sits in the seat. A swimmer entering the boat from the water may be able to more quickly dry off using a seat with the airflow provided as described herein.

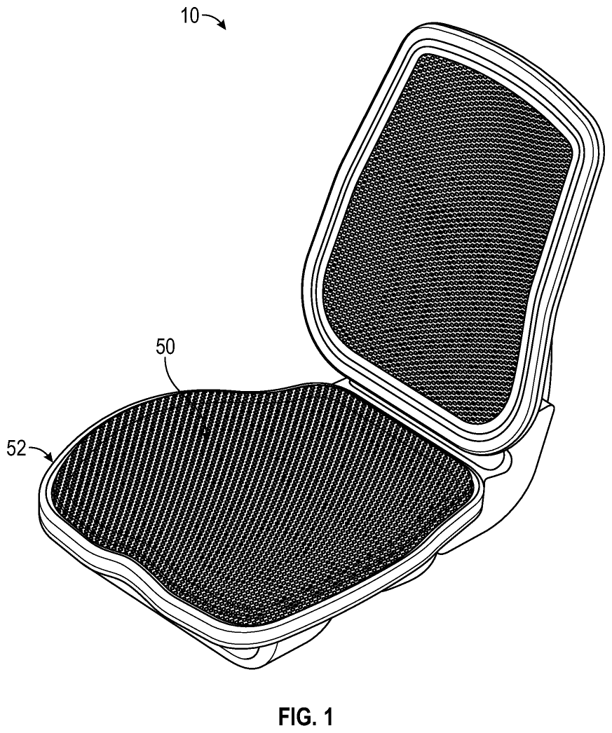

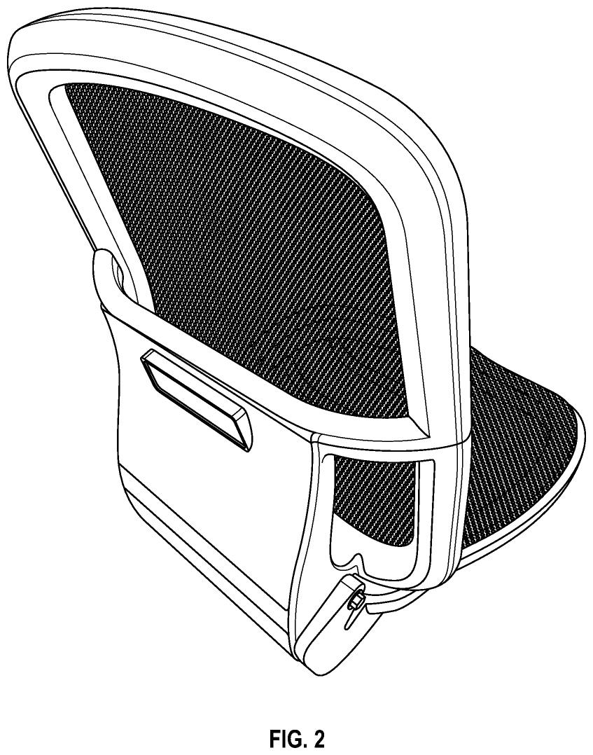

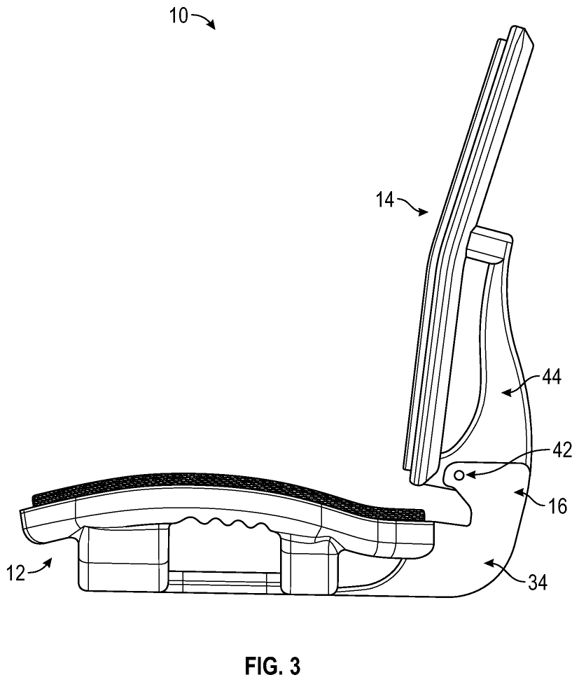

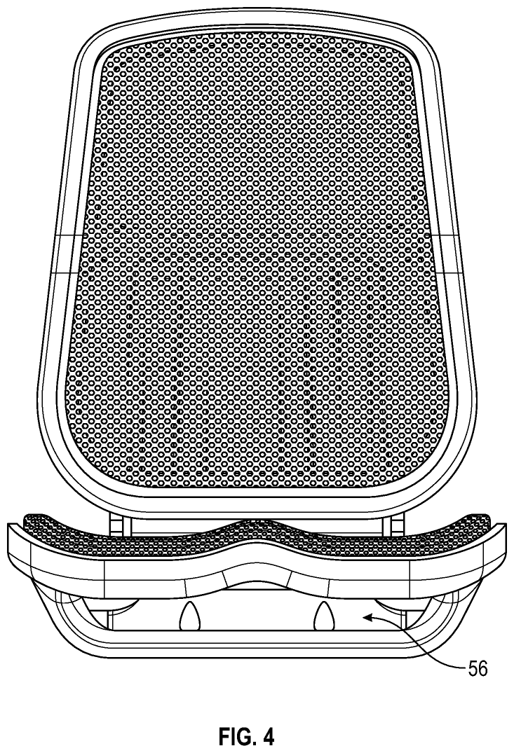

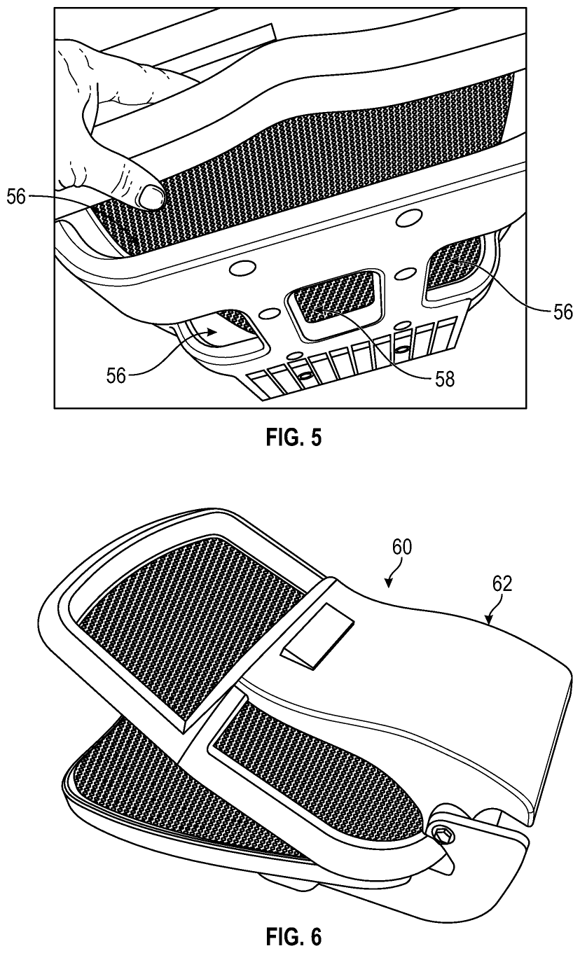

In further detail, one embodiment of a non-metal seat 10 is illustrated in FIGS. 1-7B. The seat 10 comprise a base frame 12 and a back frame 14 that are connected by a pivotal connection mechanism 16. The base frame 12 comprises a framework perimeter 18 providing an opening 20 for supporting a seat 22 thereacross. The base frame 12 may have additional frame members 24 for structural support with openings 56 there between. The base frame 12 provides one or more openings 56 and 58 between the perimeter 18 and the additional frame members 24. These openings 56 and 58 provide for additional air flow paths below the seat 22 supported on the perimeter 18. That is, the seat 22 comprises a fabric 50 that contacts the base frame 12 in one embodiment only around the perimeter 18. The seat 22 is suspended across the opening 20 within the perimeter 18 and with sufficient tension to maintain one or more air flow paths between the seat 22 and any additional frame members 24 there below. This allows the seat 10 to provide air flow and thus have a cooling effect below the seat 22.

The back frame 14 comprises a framework perimeter 26 providing an opening 28 for supporting a back rest 30 thereacross. The back frame 14 may also have additional frame members 32 for structural support. One or more air flow paths for cooling may also be provided on the back frame 14 such that the fabric 50 is stretched across and suspending across the opening 28 within the perimeter 26 of the back frame. This allows the seat 10 to provide air flow and thus have a cooling effect around the back support of the seat 10.

The connection mechanism 16 may comprise a base connector 34 and a back connector 44, which are pivotally secured to one another. For example, the base connector 34 is integrally connected to the base frame 12 and extends upwardly from a bottom surface of, or connection to, the base frame 12. The base connector 34 may be a rear base wall 36 that is curved, has an arcuate length or is otherwise provided with an elbow such that the rear base wall 36 extends upwardly from connection to the rear of the base frame 12. The base connector 34 further comprises a surface 38 for coupling to the back connector 44.

The back connector 44 is also integrally connected to the back frame 14. The back connector 44 may extend downwardly from a surface of the back frame 14, such as frame member 32. A lower end 46 of the back connector 44 may then align with and pivotally couple to an upper end 40 of the base connector 34. In the embodiment illustrated, the seat 10 has a pivot point 42 that is positioned at or above a top surface of the seat 22 supported across the base frame 12.

The back connection 44 may have a rear surface 60 with a curvature 62 such that when the seat is in a folded, collapsed configuration as illustrated in one embodiment in FIG. 6. Thus, the seat 10 can be folded down and collapsed and the folded seat 10 used as a back rest and/or bump seat. The curvature supports a user as a backless seat or bump seat and can be leaned against or sat upon. When installed, the seat can be used in a dual configuration, in the open configuration for use in the manner of a chair or seat and in the closed, folded configuration can be a backless seat or bump seat for leaning against and/or sitting on.

In one embodiment, the base connector 34 and back connector 44 have surface dimensions which allow the upper end 40 of the base connector 34 to mate with or otherwise couple to the lower end 46 of the back connector 44. In one or more embodiments, a pivotal connection is provided to couple the ends 40 and 46. For example, the connection may be provided by knobs extending outwardly from side edges of one of the upper end 40 or the lower end 46 which rotatably couple to corresponding apertures in one of the upper end 40 or lower end 46 to allow the base 12 and back 14 to selectively collapse with respect to one another. Additional or alternative mechanisms for pivoting connection include a pivot rod extending from connection with upper end 40 through and/or to connection with the lower end 46. The pivot point 42 may also be provided with a lock to secure the seat 10 in a selected orientation, such that when the base 12 and back 14 are open for use as a seat, the base 12 and back are secured in position with respect to one another.

In one or more embodiments the connection of the upper end 40 and lower end 46 may be rigid but flexible such that a user may sit on the seat 22 and lean back into the back rest 30 with sufficient force to nominally displace or recline the back frame 14 to an extent in the range of about a 1 to 10 degrees or 2 to 5 degrees recline from the substantially upright or open seating orientation. When leaning forward the surfaces are resilient and allow the back frame 14 to return automatically to a substantially upright seating orientation.

The seat 22 and the back rest 30 may be comprised of a non-metal mesh fabric 50. The non-metal mesh fabric 50 may be constructed of plastic, other polymeric materials and/or the like. In addition, the mesh fabric 50 can comprise one or more layers, to provide seats 10 of varying comfort and/or weight limits. The mesh fabric 50 on the seat 22 and/or back rest 30 may comprise one or more panels of different non-metal mesh fabric constructions. In general, the mesh fabric 50 is a flexible, open weave material that is configured to permit air and other fluids to pass through it. Mesh fabric 50 is coupled to the base frame 12 and back frame 14. The base frame 12, back frame 14, the connection between the mesh fabric 50 and the base frame 12, the connection between the mesh fabric 50 and the back frame 14, and/or one or more other seat 10 assembly features and components can be advantageously configured to adequately and safely support the weight of a user.

The mesh fabric 50 may be securely coupled to and stretched across each of the base frame 12 and back frame 14. For example, a perimeter 52 of the mesh fabric 50 is secured to the base frame 12 by one or more clamping mechanisms 54. In one embodiment the perimeter base frame 12 is provided with a slot or opening 54 for receiving the perimeter 52 of the mesh fabric 50 and clamping the same therein.

The base frame 12 and non-metal mesh seat 22 thereon is also pivotally secured to the back frame 14 and non-metal mesh backrest 30 thereon. The base frame 12 and back frame 14 may be pivotally coupled in a manner that allows the back frame 14 to fold down over and on top of the base frame 12. Dimensions of the base frame 12 and back frame 14 may allow for the back frame 14 to fold down and nest in or on top of the base frame 12 wherein one or more surfaces of the base frame 12 and back frame 14 are in direct contact with one another for a compact storage position.

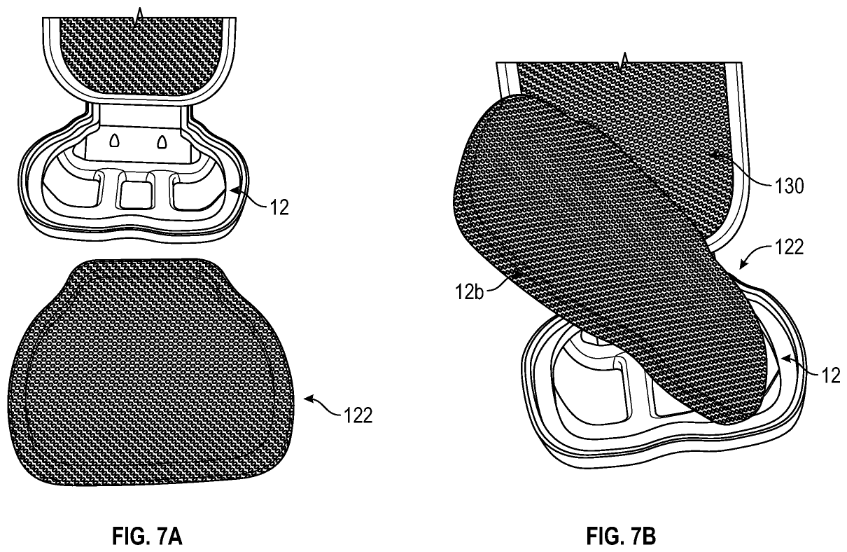

As illustrated in FIGS. 7A and 7B, one or both of the mesh seat 22 and/or the backrest 30 are removable and interchangeable or replaceable panels 122 and 130. That is, the panels 122 and/or 130 comprise the mesh fabric 50 stretched across a frame 12b and/or 12a and secured to the rear side thereof with a fastening mechanism such as an adhesive, staples, clamps, tacks, or other fasteners. The panels 122 and/or 130 have frames 12b and 12a that are then configured with perimeter dimensions to snugly nest within and mate with an inner perimeter of the respective frame 12 and/or 14 of the seat 10. Each frame 12 and 14 may be provided with a ledge or floor wall and side wall configuration such that the panels 122 and/or 130 fit in and are supported by the frame 12 and 14. The fit is tightly nested but may be reinforced with one or more fasteners such as clips, fittings, bolts, ties or other fasteners that may secure the removable panel 122 and/or 130 to the seat but allow for removal and/or exchange of panels 122 and/or 130 as necessary or needed. The removable nature of the panels 122 and/or 130 allow for customization of the mesh fabric, replacement and repair without requiring replacement of the seat 10 frame itself.

The seat 10 is also provided with a bottom surface to the base frame 12 that allows the seat to be installed on various types of watercrafts for use. The bottom surface of the seat 10 may have one or more openings or apertures for mounting the seat 10 for use in various watercraft. The seat 10 may be a replacement seat for pre-existing watercraft of various sizes and styles. Additionally, or alternatively, the seat may be a factory installation provided in new watercraft.

While a seat 10 is described herein, the seat 10 may have dimensions modified to provide a bench seat for multiple users or comprise multi-seat seating assemblies.

In one or more embodiments the seat 10 is entirely non-metal.

In one or more embodiments the seat 10 has a single part, monolithic framework that is constructed by a molding process, such as injection molding.

In one or more embodiments, the seat 10 may have a surface texture applied to or integrated with one or more components, including but not limited to the base frame 12 and back frame 14. This texture may be imparted during construction of the seat and/or applied after construction by way of coatings or coverings. In the embodiment illustrated, the texture is gripping texture imparted into the seat 10 material during forming of the plastic seat. The texture is applied such that one or more areas of the seat 10 framework are not smooth, and instead have a texture imparted for aiding in grip and reducing slip especially as the seat can be installed on a watercraft and may get wet and become slippery.

In one or more embodiments, one or more areas of the base frame 12 and/or back frame 14 may be provided with one or more mounting apertures, clips or other structural surface features for the attachment of various accessories for customization of the seat 10. For example, one or more frame 12 or 14 surfaces may be provided with a mounting mechanism for securing a cup holder, accessory holder, rod or reel holder or other surface for holding various shaped items. Additionally, hooks for hanging an item such as clothing, towels or hats may be provided on the back or rear surface of the back frame 14 of the seat 10.

Although the present disclosure has been described with reference to preferred embodiments, workers skilled in the art will recognize that changes may be made in form and detail without departing from the spirit and scope of the disclosure.

1. A seat for a watercraft, the seat comprising:
a non-metal seat frame comprising:
a first frame; and
a second frame, and
a non-metal open mesh fabric provided on the first frame, provided on the second frame or a combination thereof.

2. The seat of claim 1 wherein the first frame comprises a perimeter frame with an opening therein and one or more cross members are provided below the opening and extending across the opening.

3. The seat of claim 2 wherein the opening supports a seating surface thereacross and wherein the seating surface is supported by the perimeter frame and wherein the one or more cross members are spaced below the seating surface and thus not in direct contact with the seating surface.

4. The seat of claim 3 wherein the seating surface is provided on a removable panel wherein the panel is removably coupled to the perimeter frame.

5. The seat of claim 1 wherein the second frame comprises a perimeter frame with an opening therein and one or more cross members are provided behind the opening and extending across the opening.

6. The seat of claim 5 wherein the opening supports a backrest thereacross and wherein the backrest is supported by the perimeter frame and wherein the one or more cross members are spaced behind the backrest and thus not in direct contact with the backrest surface.

7. The seat of claim 6 wherein the backrest surface is provided on a removable panel wherein the panel is removably coupled to the perimeter frame.

8. The seat of claim 1 wherein one or more air flow paths are provided below or behind the non-metal open mesh fabric provided on the first frame and/or the second frame.

9. The seat of claim 1 wherein the first frame is provided with the non-metal open mesh fabric such that the first frame provides a seating surface configured to withstand a user seated thereon and wherein the second frame is provided with non-metal open mesh fabric such that the second frame provides a backrest surface to the seat.

10. The seat of claim 9 wherein the first frame and second frame are pivotally coupled together by a pivotal connection mechanism such that the seat is a selectively collapsible seat for storage and transport.

11. The seat of claim 10 wherein the pivotal connection mechanism is positioned at a location above a seating surface of the first frame.

12. The seat of claim 1 wherein the second frame is provided with a support member spaced apart from the non-metal open mesh fabric on the second frame and has an outer surface curvature.

13. The seat of claim 12 wherein the seat is collapsible such that the second frame is pivotal about the pivotal connection mechanism to contact the first frame and wherein the seat can double as a bump seat.

14. The seat of claim 1 wherein the non-metal open mesh fabric is comprised of a knit or woven plastic, polymer, or combination thereof and wherein the fabric is stretched across one or both of the first frame and the second frame.

15. The seat of claim 1 wherein the seat comprises an attachment mechanism for installing the seat on a pre-existing seat support of the watercraft.

16. A non-metal seat comprising a non-metal frame work and a non-metal open mesh seating surface stretched across an opening in a base portion of the non-metal framework and wherein the non-metal frame is constructed from plastic and the non-metal open mesh comprises a woven or knit open mesh panel comprising nylon, vinyl, or a combination thereof.

17. The non-metal seat of claim 16 and further comprising a non-metal open mesh backrest surface stretched across an opening in a back support portion of the non-metal framework.

18. The non-metal seat of claim 16 and further comprising a pivoting mechanism coupling the base portion to the backrest support portion such that the non-metal seat is a foldable seat.

19. The non-metal seat of claim 16 where in the non-metal open mesh seating surface is stretched across the opening in the base portion of the non-metal framework and spaced apart from one or more frame support members extending across and below the non-metal framework such that the open mesh is not in contact with the one or more frame support members.

20. The non-metal seat of claim 16 where in the non-metal open mesh backrest surface is stretched across the opening in the backrest support portion of the non-metal framework and spaced apart from a support member extending across and behind the non-metal framework such that the open mesh is not in contact with the support member.
